(19) United States
(12) Patent Application Publication
(10) Pub. No.: US 2018/0343578 A1
(43) Pub. Date: Nov. 29, 2018

(54) METHOD AND SYSTEM FOR IMPROVING THE UE WLAN MEASUREMENT REPORTING IN LTE WLAN LINK AGGREGATION

(71) Applicant: Telekom Malaysia Berhad, Kuala Lumpur (MY)

(72) Inventors: Chun Yeow YEOH, Petaling Jaya (MY); Ahmad Kamsani Bin SAMINGAN, Bandar Baru Bangi (MY); Ishak Bin SULEIMAN, Durian Tunggal (MY); Abdul Aziz Bin ABDUL RAHMAN, Kuala Lumpur (MY); Noor Aisyah Binti MOHD AKIB, Batu Caves (MY)

(21) Appl. No.: 15/880,484

(22) Filed: Jan. 25, 2018

(30) Foreign Application Priority Data
May 23, 2017 (MY) PI 2017000768

(51) Int. Cl. H04W 24/10; H04W 72/12; H04W 24/08; H04W 28/02; H04W 16/14; H04W 8/24

(52) U.S. Cl. CPC H04W 24/10; H04W 72/1215; H04W 24/08; H04W 88/06; H04W 16/14; H04W 8/24; H04W 28/0215

(57) ABSTRACT

A method and system for improving the UE WLAN measurement reporting for both LWA and LWIP, wherein both LWA and LWIP comprises a eNB, a WLAN AP/AC and a UE. In one embodiment, the method comprises notifying the eNB by the UE for its support of LWA or LWIP and WLAN reporting via LTE radio resource; instructing the UE by the eNB to perform initial WLAN measurement; sending the initial WLAN measurement report to the eNB via LTE radio resource by the UE; instructing the UE by the eNB to be associated to a WLAN AP/AC selected by the eNB; performing post-association WLAN measurement periodically to generate post-association measurement report; determining if a WLAN event is triggered; if No, performing the WLAN measurement periodically; if Yes, the UE sends the post-association WLAN measurement report to the eNB via WLAN radio resource and then performing the WLAN measurement periodically.

### FIELD OF THE INVENTION

The present invention relates to the wireless communication systems, and more specifically to a method for improving the UE WLAN measurement reporting in LTE WLAN link aggregation for a wireless communication system and also to a wireless communication system with improved UE WLAN measurement reporting in LTE WLAN link aggregation.

### BACKGROUND OF THE INVENTION

Due to growing traffic demand and increasing importance for unlicensed spectrum, 3GPP has defined network controlled LTE WLAN Aggregation (LWA) in Release 13, supporting both collocated and non-collocated scenarios as defined in 3GPP TS 36.300 v13.3.0. FIG. 1 illustrates exemplary non-collocated LWA architecture. As shown in FIG. 1, the exemplary non-collocated LWA comprises a Mobility Management Entity (MME) and Serving Gateway (S-GW) (101) forming an EPC core, an evolved Node B (eNB) (102) being logically connected to the MME/S-GW, a WLAN Access Point (AP) or Access Controller (AC) (WLAN AP/AC) (103), a User Equipment (UE) (104), and a logical interface (Xw interface) (105). The Xw interface (105) logically connects the eNB (102) and WLAN AP/AC (103). For LWA in a non-collocated scenario, the Xw interface (105) is not required. The UE (104) is in Radio Resource Control (RRC) connected state with the eNB (102) and associated with the WLAN AP/AC (103); the UE (104) can be configured by the eNB (102) to utilize both radio resources at the same time.

The introduction of the Xw interface (105) in FIG. 1, however, requires significant development work on the WLAN AP/AC (103) to support LWA. As an alternative, 3GPP has defined the LTE/WLAN Radio Level Integration with IPsec Tunneling (LWIP). FIG. 2 illustrates exemplary non-collocated LWIP architecture comprising a MME/S-GW (201), an eNB (202) being logically connected to the MME/S-GW, a WLAN AP/AC (203), a UE (204), and an IPsec tunnel (205), allowing the configuration of data bearer over the WLAN by the eNB (202) and traffic to be routed through an IPsec tunnel (205) via WLAN AP/AC (203) to the UE (204).

FIGS. 3 and 4 are flow charts illustrating the procedures for LWA and LWIP respectively. Both procedures are first triggered by an eNB requesting a UE to report its support on LWA or LWIP using RRC message, known as UE Capacity Enquiry (301), (401). The UE responds with UE Capability Information message (302), (402) with Information Elements (IEs), known as lwa-r13 or lwip-r13, indicating supported. FIG. 5 shows an exemplary UE-EUTRA-Capability Information element related to LWA and LWIP. The eNB then instructs the UE to carry out the WLAN measurement based on either the band or the carrier info with optional of WLAN identifiers by sending the RRC Connection Reconfiguration message (303), (403) to the UE. WLAN identifier can be Basic Service Set Identifier (BSSID). Service Set Identifier (SSID) or Homogeneous Extended Service Set Identifier (HESSID). Table 1 shows the description of the WLAN identifiers. Then, the UE replies with RRC Connection Reconfiguration message (304), (404) to the eNB and starts to perform the WLAN measurement accordingly.

TABLE 1
WLAN Identifier Description

| Identifier | Description |
|---|---|
| BSSID | For infrastructure BSS, the BSSID is the MAC address of the |
| | wifeless access point |
| SSID | The SSID can be used in multiple, possibly overlapping, BSSs |
| HESSID | A MAC address whose value shall be configured by the |
| | Hotspot Operator with the same value as the BSSID of one |
| | of the APs in the network. All APs in the wireless |
| | network shall be configured with the same HESSID value. |

Referring still to FIGS. 3 and 4, after the UE has performed either active scanning or passive scanning as according to IEEE 802.11-2012, the scanning results are encapsulated in the Measurement Report message sent to the cNB (305), (405). With active scan, the UE transmits a probe request frame and listens to a probe response frame from a WLAN AP. Meanwhile, with passive scan, the UE listens on each channel for beacons transmitted periodically by a WLAN AP. The scanning procedures are further expedited in the IEEE 802.11ai standardization. The WLAN measurement reporting is used by the eNB to determine whether the WLAN conditions are satisfied to activate the LWA/LWIP or moving the UE from one WLAN mobility set to another. A WLAN mobility set is a set of one or more WLAN APs identified by one or more BSSID/HESSID/SSIDs. If the eNB decides to activate LWA, the eNB is required to first send the WT Addition Request message (306) via Xw interface to WLAN AP/AC requesting the required resources. E-UTRAN Radio Access Bearer (E-RAB) Identifier (ID), GTP tunnel endpoint and QoS parameters are specified in the WT Addition Request message. The WLAN AP/AC replies with WT Addition Request Acknowledge message (307) if the resources can be satisfied. However, these procedures are not required for LWIP since there is no direct communication between the WLAN AP/AC and the eNB.

Referring still to FIGS. 3 and 4, the eNB subsequently instructs the UE to configure the LWA or LWIP using the RRC Connection Reconfiguration message (308), (406). This is to allow the UE to configure the LWA and LWIP support based on the WLAN-MobilitvConfig IE (309), (407). For LWIP, additional Tunnel/ConfigLWIP IE is used to setup the IPSec tunneling between the eNB and the UE. For LWA, once the UE associated to the respective WLAN AP/AC, the WLAN AP/AC notifies the eNB using the WT Association Confirmation message (310) and data can now be sent utilizing two different radio resources. LTE and WLAN (311). For LWIP, the WLAN Connection Status Report message (408) is sent by the UE to inform the status of WLAN association attempt since there is no communication between the WLAN AP/AC and eNB directly. If the UE indicates the successful association, the data can now be sent utilizing two different radio resources. LTE and WLAN, using the IPSec tunnel (409). For LWA, feedback and flow control information for user plane is sent by UE and WLAN AP/AC via LWA/PDCP Status Report (313) and DL Data Delivery Status (312) respectively. For LWIP, the feedback MeasurementReport is sent to the eNB (410).

LTE small cell and WLAN AP/AC deployed in the high-density area, such as enterprises, stadiums, convention centers, auditoriums, shopping malls and etc. can be beneficial from LWA and LWIP. As discussed earlier, both LWA and LWIP still need to rely on the LTE licensed spectrum for WLAN measurement reporting. If the threshold value for event W1, W2 and W3 are set too low, this can cause frequent occurrence of Measurement Report message in an LTE network. On the other hand, if the threshold value for event W1. W2 and W3 are set too high, the infrequent occurrence of Measurement Report message in an LTE network hinders the eNB to determine the optimized WLAN AP/AC for LWA and LWIP. In addition, venue owners may also introduce new WLAN AP/AC with different set of WLAN identifier. The measurement performed by the UE is not completely reported to the eNB because the Measurement Report message excludes the non-targeted WLAN identifiers.

US 20150245409 A1 discloses the methods and systems for intelligent aggregation and management of a plurality of network interfaces and connections. The intelligent connection manager may monitor connection and application communication parameters, and can control the distribution of traffics via different connections. The monitor parameters are connection related or IP packet related, such as bandwidth or bitrate, latency, round trip communications time, congestion levels, packet loss rates, signal to noise ratios, maximum transmission unit (MTU) sizes, buffer sizes or fullness, and window sizes. No disclosure relates to the RSSI monitoring on WLAN radio resources.

US 20150043560 A1 discloses the methods and apparatuses for improving measurement reporting involving WLAN for a UE in a wireless communication system. The method includes triggering a transmission of a measurement report involving WLAN due to at least one condition being fulfilled, where the at least one condition includes a first condition related to WLAN load. The improvement disclosed is still based on sending the UE WLAN measurement report using LTE radio resource and no specific disclosures are related to non-targeted WLAN identifiers.

US 20140369329 A1 discloses the techniques of aggregating wireless communications in a femtocell with portion of data transmission via a Long Term Evolution (LTE) interface and another portion of data transmission via a WiFi interface of the wireless router. Although the aggregation policy is based on the channel characteristics of the LTE and WiFi, it fails to disclose the method on how to conduct the measurement to obtain these channel characteristics.

U.S. Pat. No. 9,232,408 B2 discloses the method and devices for providing measurements of WiFi network channels to a cellular radio. A cellular radio transceiver is configured to send the request of WiFi channel measurement to at least one identified user equipments and also to receive the WiFi channel measurement. It emphasizes on using the WiFi transceiver in the user equipments to perform the measurement and depends on the cellular radio to do the reporting.

All the above discussed patents and publications have mainly discussed or disclosed the method related to aggregating traffic utilizing both LTE and WiFi radio resources. The measurement report triggered by the UE on WLAN channel is based on the LTE radio resource due to that the control plane is still anchored by LTE network.

Therefore, there is an imperative need for a method and system for improving the UE WLAN measurement reporting in LTE WLAN link aggregation by reducing the usage of LTE radio resources by the Measurement reporting and including non-targeted identifiers within the proximity of a UE.

### SUMMARY OF THE INVENTION

The present invention provides a method for improving the UE WLAN measurement reporting for both LWA and LWIP, wherein both LWA and LWIP comprises a eNB, a WLAN AP/AC and a UE. In one embodiment, the method comprises notifying the eNB by the UE for its support of LWA or LWIP and WLAN reporting via LTE radio resource; instructing the UE by the eNB to perform initial WLAN measurement; sending the initial WLAN measurement report to the eNB via LTE radio resource by the UE: instructing the UE by the eNB to be associated to a WLAN AP/AC selected by the eNB; performing post-association WLAN measurement periodically to generate post-association measurement report; determining if a WLAN event is triggered; if No, performing the WLAN measurement periodically; if Yes, the UE sends the post-association WLAN measurement report to the eNB via WLAN radio resource and then performing the WLAN measurement periodically.

In another embodiment of the method, before the step of notifying the eNB by the UE for its support of LWA or LWIP and WLAN reporting via LTE radio resource, further comprising: sending a request by the eNB to a UE for the UE capability using UE Capability Enquiry message; thereby the UE notifies the eNB with the support of LWA and WLAN measurement reporting via LTE radio resource using UE Capability Information message.

In another embodiment of the method, the UE Capability Information message comprises a UE-EUTRA-Capability information element, wherein the support of WLAN measurement reporting via LTE radio resource is indicated by using additional fields in the UE EUTRA Capability information element, known as lwa-wlan-reporting and lwip-wlan-reporting in the LWA-parameters and LWIP parameters respectively.

In another embodiment of the method, the step of instructing the UE by the eNB to associate to a WLAN AP/AC selected by the eNB comprises: sending by the eNB a RRC Connection Reconfiguration message to the UE; replying by the UE with a RRC Connection Reconfiguration Complete message to the eNB; for LWA, the associated WLAN AP/AC notifies the eNB about the UE association using WT Association Confirmation message via Xw interface; for LWIP, the UE notifies its WLAN association status to the eNB using the WLAN Connection Status Report message.

In another embodiment of the method, in the step of determining if a WLAN event is triggered, the event includes: WLAN becomes better than a threshold; all WLAN inside WLAN mobility set become worse than a threshold 1 and a WLAN outside WLAN mobility set become better than a threshold 2; all WLAN inside WLAN mobility set become worse than a threshold.

In another embodiment of the method, the post-association WLAN measurement report includes additional fields that are appeared in pair, known as non-wlan-identifiers and rssiWLAN, in the MeasResultWLAN IE.

In another embodiment of the method, when the UE sends the post-association WLAN measurement report to the eNB via WLAN radio resource, depending upon LWA or LWIP: for LWA, the post-association WLAN measurement report is first sent from the UE to its associated WLAN AP/AC; then the MeasResultWLAN IE is directly encapsulated to the vendor specific element of IEEE 802.11 probe request management frame; and then the associated WLAN AP/AC reroutes the post-association WLAN measurement report to the eNB via Xw interface using WT Status Report message applying additional RSSI IE related to specified BSSID; for LWIP, the post-association WLAN measurement report is directly sent to the eNB via IPSec Tunnel via WLAN radio resource; wherein the post-association WLAN measurement report comprising the MeasResultWLAN IE is sent encapsulating as the LWIPEP SDU.

In another embodiment of the method, the post-association WLAN measurement report includes targeted and non-targeted WLAN identifiers.

The present invention also provides a wireless communication system with improved UE WLAN measurement reporting. In one embodiment, the wireless communication system comprises a Mobility Management Entity (MME) and Serving Gateway (S-GW), an evolved Node B (eNB) being logically connected to the MME/S-GW, a User Equipment (UE), a WLAN AP/AC with Targeted WLAN identifiers, and a WLAN AP/AC with non-Targeted WLAN identifiers; wherein the UE performs WLAN measurement periodically after being associated with one WLAN AP/AC, and sends post-association WLAN measurement report to the eNB via WLAN radio resource.

In another embodiment of the wireless communication system, the UE is embedded with an electronically executable program for performing the following operations: initializing its WLAN transceiver, performing active or passive scanning as instructed by the eNB for WLAN measurement and generates an initial or pre-association measurement report; sending the initial or pre-association WLAN measurement report to the eNB via LTE radio resource; associating to the WLAN AP/AC selected by eNB based on the command from the eNB; performing the scanning periodically to generate post-association WLAN measurement reports; determining if the WLAN event as defined in Table 2 is fulfilled; if No, keeping performing periodic scanning; if Yes, sending the post-association WLAN measurement reports to the eNB via WLAN radio resource.

In another embodiment of the wireless communication system, the electronically executable program further comprises the following operations: determining if there is a command from the eNB to instruct the UE to associate with another newly selected WLAN AP/AC; if No, keeping performing periodic scanning and reporting the measurement via WLAN radio resource; if Yes, associating with the newly selected WLAN AP/AC, and keeping periodic scanning and reporting the measurement via WLAN radio resource.

In another embodiment of the wireless communication system, the eNB is embedded with an electronically executable program for performing the following operations: sending a command to instruct the UE to perform WLAN scanning after being notified by the UE on its support of LWA and LWIP; receiving initial or pre-association WLAN measurement results via LTE radio resource; selecting a WLAN AP/AC for the UE to be associated to, and sends a command to the UE to associate to the selected WLAN AP/AC; deciding whether the UE is LWA-enabled or LWIP-enabled; if the UE is LWA-enabled, awaiting the UE WLAN association status reporting from the WLAN AP/AC; if the UE is LWIP-enable, awaiting the UE WLAN association status reporting from the UE; deciding whether the UE is LWA-enabled or LWIP-enabled; if the UE is LWA-enabled, receiving the WT status report comprising the RSSI of targeted WLAN identifiers and non-targeted WLAN identifiers via WLAN radio resource; if the UE is LWIP-enabled, receiving the UE WLAN measurement report comprising RSSI of targeted and non-targeted WLAN identifiers using IPSec tunnel via WLAN radio resource; performing filtering and sorting algorithm of targeted and non-targeted WLAN identifiers; selecting WLAN AP/AC for traffic aggregation considering non-targeted WLAN identifier and other related WLAN metrics; if the selected WLAN AP/AC for traffic aggregation is a non-targeted WLAN identifier, it will be converted to targeted WLAN identifier.

In another embodiment of the wireless communication system, the filtering and sorting algorithm of targeted and non-targeted WLAN identifiers comprises the following operations: receiving RSSI measurement from non-targeted WLAN identifier; determining if the OUI of the non-targeted WLAN identifier matches the OUI of BSSID for at least one of the targeted WLAN identifiers; if Yes, determining if the RSSI of the non-targeted WLAN identifier is larger than the defined RSSI threshold; if No, filtering out the RSSI measurement for the non-targeted WLAN identifier; if Yes, sorting the RSSI measurement for non-targeted WLAN identifier together with targeted WLAN identifiers.

In another embodiment of the wireless communication system, the RSSI threshold can be based on the average or median of RSSI for targeted WLAN identifiers.

The objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 illustrates exemplary non-collocated LWA architecture.

FIG. 2 illustrates exemplary non-collocated LWIP architecture.

FIG. 3 shows a flow chart illustrating the procedures for LWA.

FIG. 4 shows a flow chart illustrating the procedures for LWIP.

FIG. 5 is a flowchart showing the procedures of LWA in accordance with embodiments of the present invention.

FIG. 6 is a flowchart showing the procedures of LWIP in accordance with embodiments of the present invention.

FIG. 7 shows an exemplary UE-EUTRA-Capability Information element related to LWA and LWIP in accordance with embodiments of the present invention. FIG. 8 shows an exemplary UE-EUTRA-Capability information element.

FIG. 9 shows an exemplary LWA-Configuration information element.

FIG. 10 shows an exemplary LWIP-Configuration information element, WLAN-MobilityConfig information element, and TunnelConfigLWIP information element.

FIG. 11 shows an exemplary MeasResultWLAN information element.

FIG. 12 shows an exemplary ReportConfiglnterRAT information element.

FIG. 13 shows an exemplary post-association MeasResultWLAN information element.

FIG. 14 shows an exemplary encapsulation of the MeasResultWLAN IE directly to the vendor specific element of IEEE 802.11 probe request management frame.

FIG. 15 shows an exemplary WT Status Report message applying additional RSSI IE related to the specified BSSID.

FIG. 16 shows LWIPEP SDU encapsulating the post-association WLAN measurement report message comprising the MeasResultWLAN IE, LWIPEP data Protocol Data Unit (PDU) and GRE header modification, for supporting RSSI measurement of targeted and non-targeted WLAN identifier reporting, used by LWIP.

FIG. 17 illustrates an exemplary wireless communication system in accordance with embodiments of the present invention.

FIG. 18 shows a flow chart of UE reporting pre-association WLAN measurement via LTE radio resource and post-association WLAN measurement via WLAN radio resource and its subsequent action based on eNB's command in accordance with embodiments of the present invention.

FIG. 19, there is provided a flow chart of eNB handling the WLAN measurement received from UE via WLAN radio resource and LTE radio resource and its subsequent action to the UE in accordance with embodiments of the present invention.

FIG. 20 shows a sorting and filtering algorithm for targeted and non-targeted WLAN identifiers in accordance with embodiments of the present invention.

FIG. 21 shows an exemplary sorting as performed in accordance with embodiments of the present invention Detailed Description of the Invention

The present invention may be understood more readily by reference to the following detailed description of certain embodiments of the invention.

Throughout this application, where publications are referenced, the disclosures of these publications are hereby incorporated by reference, in their entireties, into this application in order to more fully describe the state of art to which this invention pertains.

The present invention provides a method for improving the UE WLAN measurement reporting for both LWA and LWIP in two ways. One is to enable a UE to transmit the UE WLAN Measurement Report via WLAN radio resource after successfully associated with WLAN AP/AC selected by eNB, reducing the usage of LTE radio resource and enhance the capacity of LTE network. The other is to include in the UE WLAN Measurement Report the non-targeted WLAN identifiers within the proximity of the UE measurement, improving the selection of WLAN AP/AC for LWA and LWIP.

Many abbreviations used in the present application are commonly known; for the sake of brevity, not all of them are provided with their full terms. For example, user equipment (UE); wireless local area network (WLAN); long term evolution (LTE); LTE WLAN Link Aggregation (LWA); LTE WLAN Radio Level Integration with IPSec Tunneling (LWIP); Access point (AP); access controller (AC); evolved Node B (eNB); WLAN Measurement Reporting; Non-targeted WLAN identifiers; Received Signal Strength Indicator (RSSI); Radio Resource Control (RRC) Signaling Message; Generic Routing Encapsulation (GRE); 3^{rd} Generation Partnership Project (3GPP) in Release 13.

Referring now to FIG. 5, there is provided a flowchart showing an abstracted process for the method for improving the UE WLAN measurement reporting for both LWA and LWIP in accordance with embodiments of the present invention. In the pre-association stage, the UE notifies the eNB its support of LWA or LWIP and WLAN reporting via LTE radio resource (501); then eNB instructs the UE to perform initial WLAN measurement (502); then the UE sends the initial WLAN measurement report to the eNB via LTE radio resource (503); then the eNB instructs the UE to associate to the WLAN AP/AC selected by the eNB (504). In the post-association stage, the UE performs the WLAN measurement periodically (505); then, is an WLAN event triggered? (506); if No, going back to step (505); if Yes, the UE sends the WLAN measurement report to the eNB via WLAN radio resource (507) and then goes back to step (505).

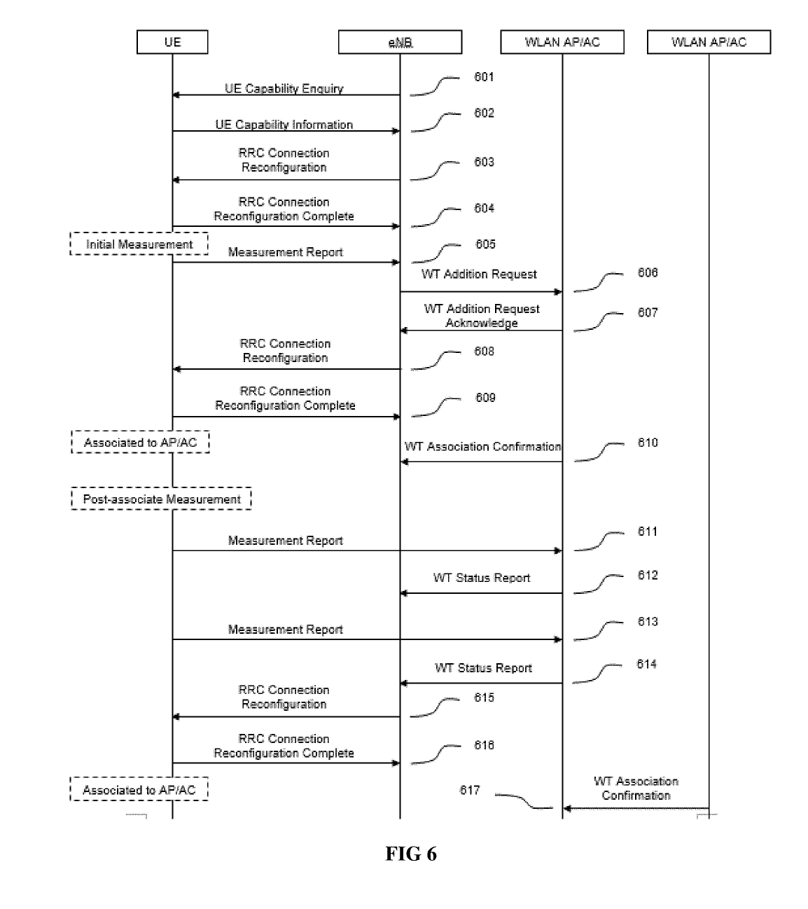

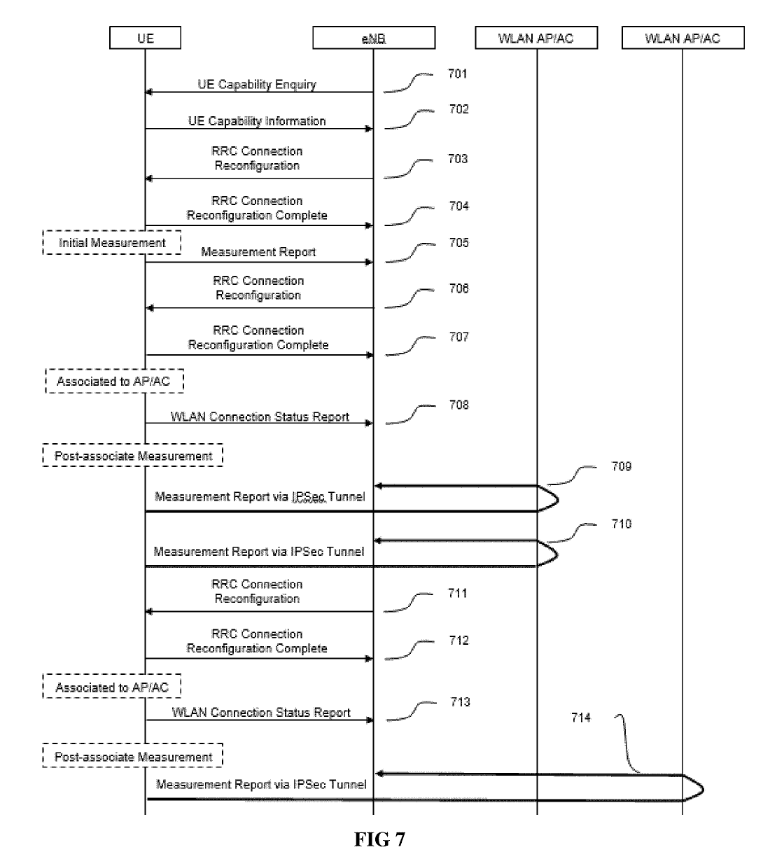

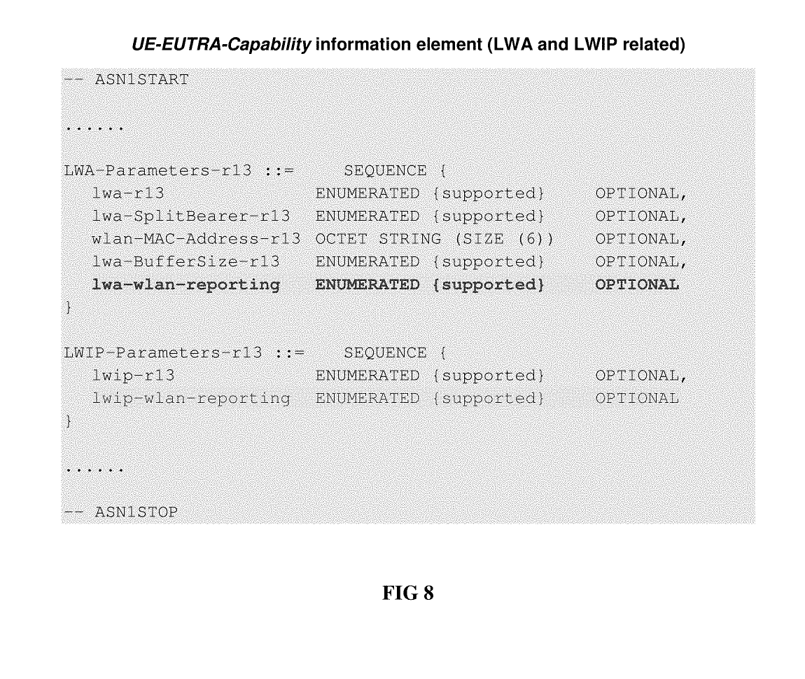

Referring now to FIGS. 6 and 7, there are provided flowcharts showing the more detailed procedures of respective LWA and LWIP in accordance with embodiments of the present invention.

As shown in FIGS. 6 and 7, the procedures commence when an eNB sends a request to a UE for the UE capability using UE Capability Enquiry message (601), (701); then UE notifies the eNB with the support of LWA and also WLAN measurement reporting via LTE radio resource using UE Capability Information message (602), (702). As shown in FIG. 8, there is provided a UE-EUTRA-Capability information element related to LWA and LWIP in accordance with embodiments of the present invention. The support of WLAN measurement reporting via LTE radio resource is indicated by using additional fields in the UE EUTRA Capability information element, known as lwa-wlan-reporting and lwip-wlan-reporting in the LWA-parameters and LWIP parameters respectively.

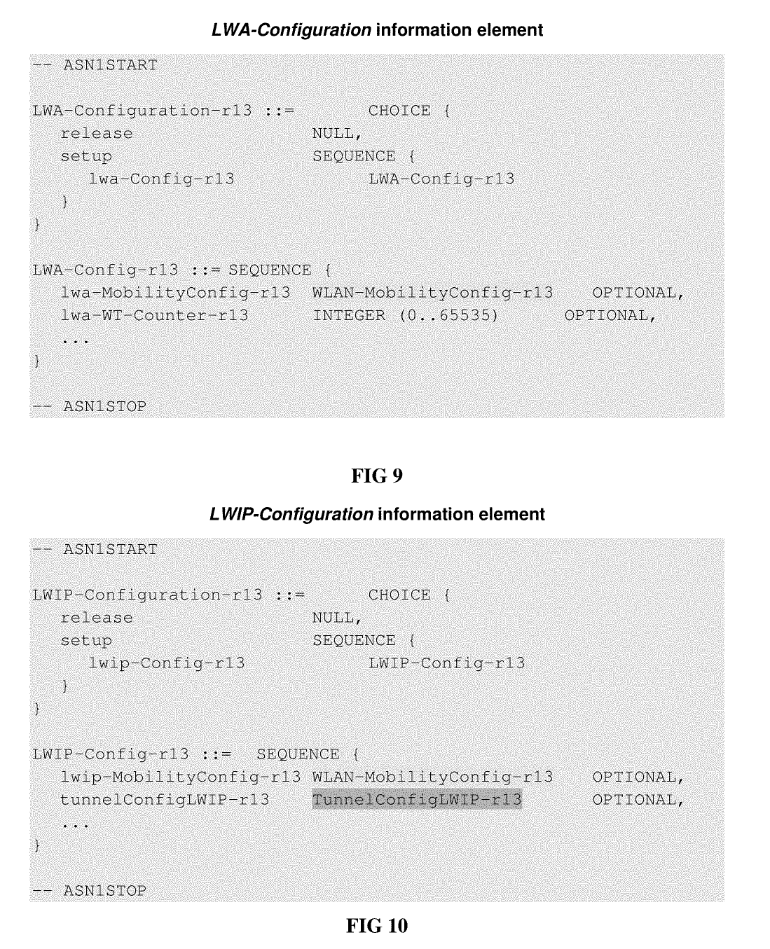

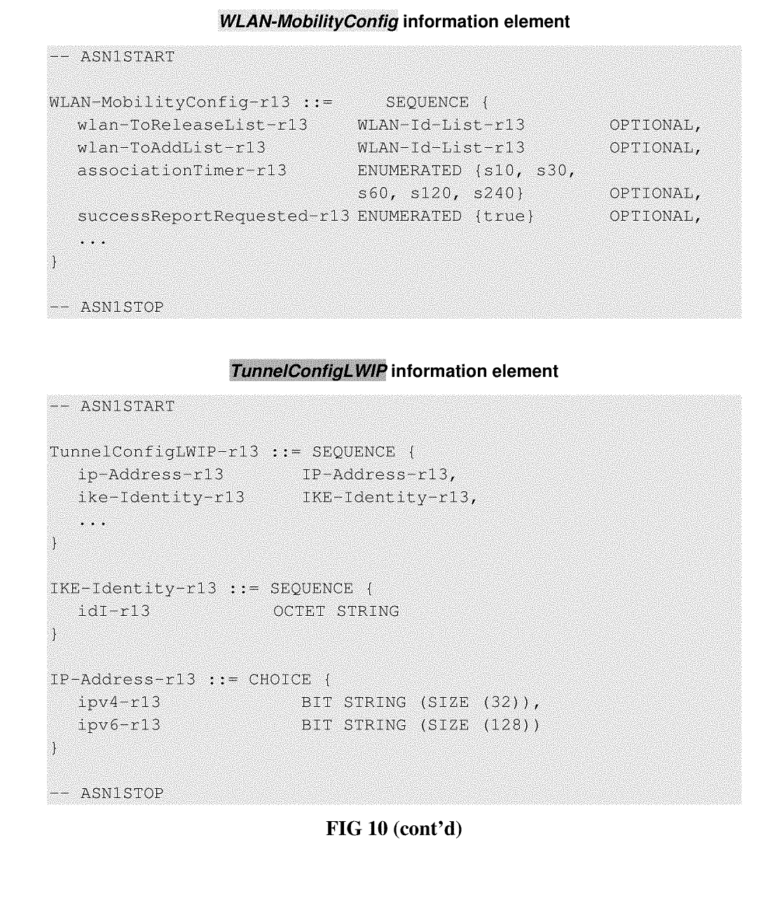

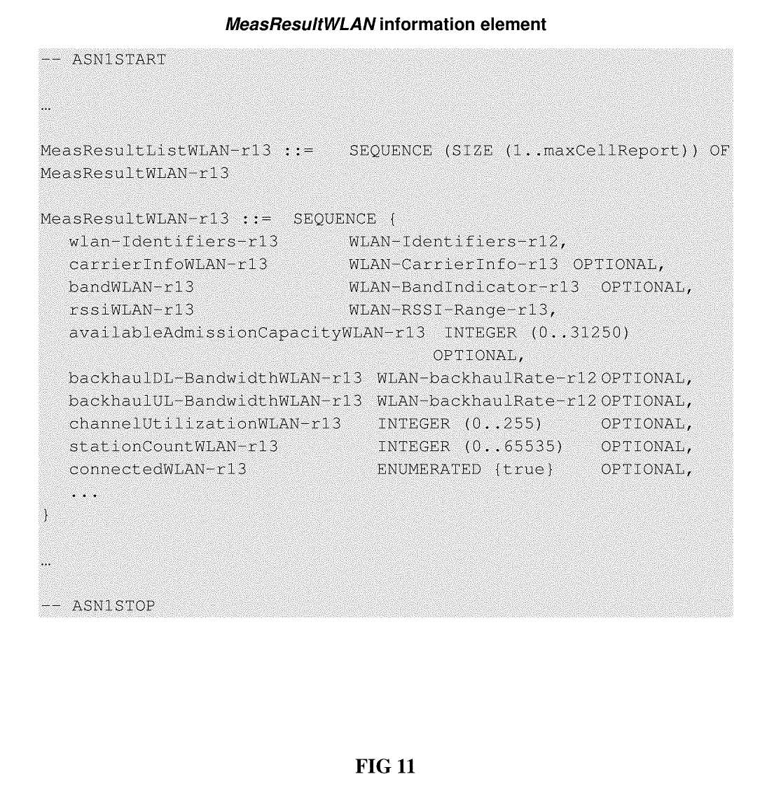

Referring still to FIGS. 6 and 7, the eNB then sends the RRC Connection Reconfiguration message (603), (703) and the UE replies with RRC Connection Reconfiguration Complete message (604), (704). FIG. 9 provides an exemplary LWA-Configuration information element; FIG. 10 provides an exemplary LWIP-Configuration information element, WLAN-MobilityConfig information element, and TunnelConfigLWIP information element. This event triggers the WLAN scanning process in the UE for initial WLAN measurement, and the UE sends the initial WLAN measurement report (805), (905) to the eNB via LTE radio resource. FIG. 11 provides an exemplary MeasResultWLAN information element. The initial WLAN measurement allows the eNB to select a WLAN AP/AC for the UE to be associated to.

Referring now to FIG. 6, for LWA, after the eNB selects the WLAN AP/AC that the UE should associate to, the eNB sends a WT Addition Request message (606) via Xw interface to the selected WLAN AP/AC. The selected WLAN AP/AC can then decide whether to accept the request of eNB based on its available resource. The selected WLAN AP/AC replies with WT Addition Request Acknowledge message (607) via Xw interface if it can support the UE association, designated as a matched WLAN AP/AC.

Referring now to FIG. 7, for LWIP, the steps of (706) and (707) for LWA are skipped since there is no Xw interface between the eNB and the WLAN AP/AC; thus, the selected WLAN AP/AC is designated as a matched WLAN AP/AC.

Referring now to FIGS. 6 and 7, the eNB then requests the UE to associate to the matched WLAN AP/AC via RRC Connection Reconfiguration message (608), (706) and the UE replies with RRC Connection Reconfiguration Complete message (609), (707). Then, the UE is associated with the matched WLAN AP/AC.

Referring now to FIG. 6, for LWA, the associated WLAN AP/AC notifies the eNB about the UE association using WT Association Confirmation message (610) via Xw interface.

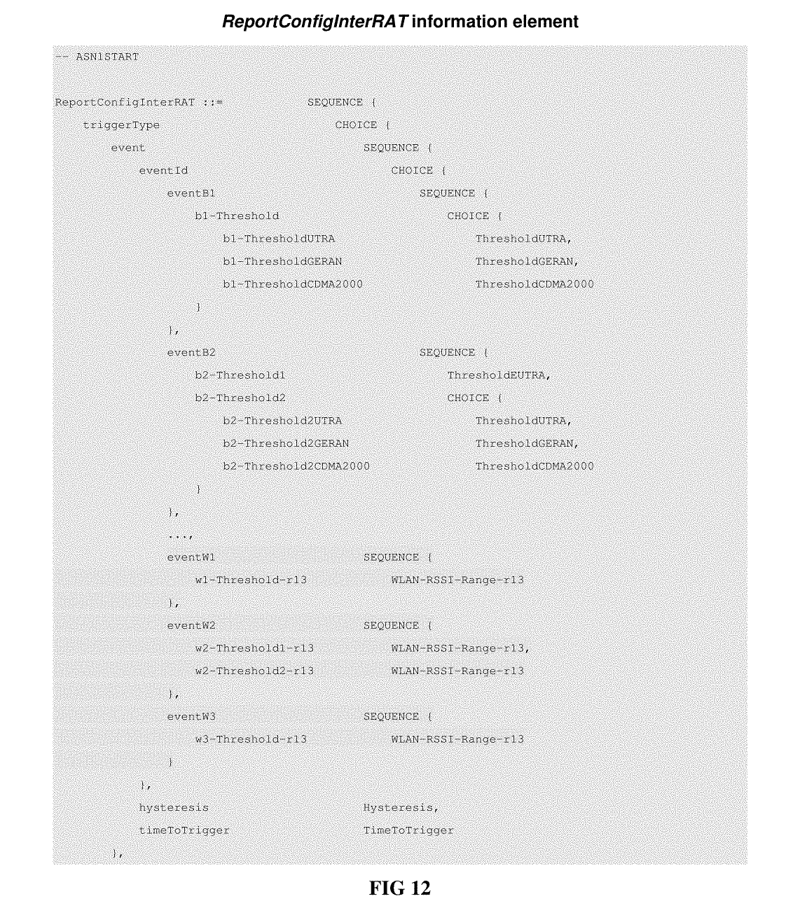

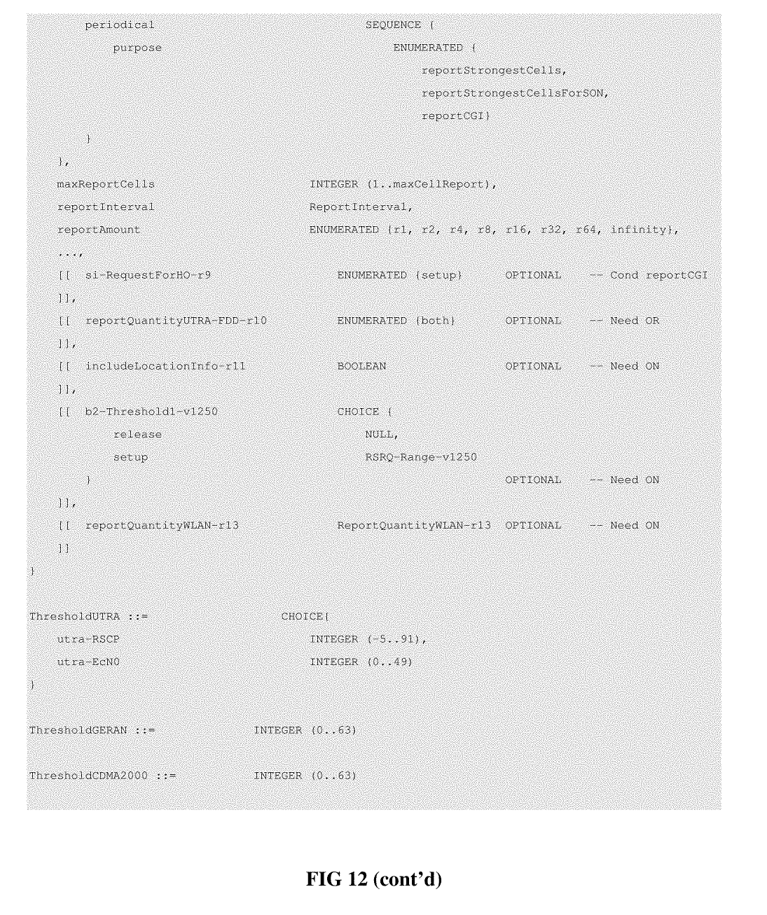

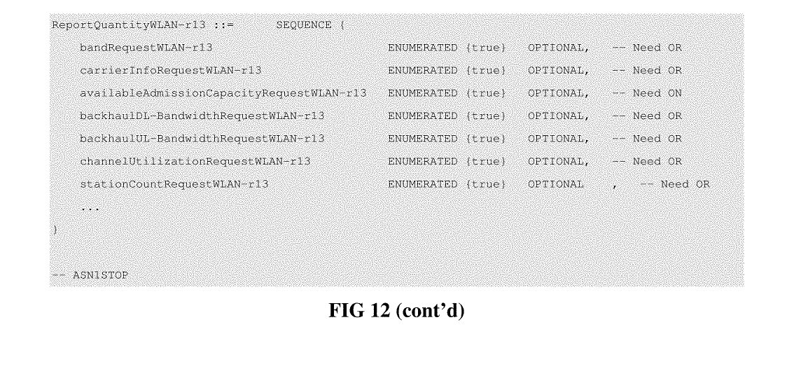

Both RRC connection control and measurement procedures are carried over LTE using Signalling Radio Bearer 1 (SRB 1) with Radio Link Control (RLC) Acknowledgment Mode (AM). The WLAN measurement results as depicted in FIG. 11 consist of important metrics for eNB to schedule the amount of traffics towards the WLAN, such Received Signal Strength Indicator (RSSI) of the WLAN Identifier, total number stations associated with the WLAN identifier, downlink and uplink bandwidth for WLAN backhaul, available admission capacity of WLAN and channel utilization of WLAN. The UE can obtain the station count, channel utilization and available admission capacity from Basic Service Set (BSS) Load element available at both beacon and probe response frames as specified in IEEE 802.11-2012 provided the WLAN supported 802.11e. The frequency of triggering the WLAN measurement reporting by the UE is based on the RSSI of the targeted WLAN identifiers. The ReportConfiglnterRAT IE in FIG. 12 contains the event to trigger the WLAN measurement reporting as defined in 3GPP TS 36.331 v13.1.0. Table 2 further describes the candidate measurement events for reporting WLAN.

Referring now to FIG. 7, for LWIP, the UE notifies its WLAN association status to the eNB using the WLAN Connection Status Report message (708).

Referring now to FIGS. 6 and 7, after the UE associates with the matched WLAN AP/AC, the UE performs post-associate WLAN measurement. The subsequent post-association WLAN measurement report messages will then be sent to the eNB via WLAN radio resource; if one of the events defined in Table 2 is fulfilled, it will trigger the reporting of the measurement report.

TABLE 2
Candidate Measurement Events for Reporting WLAN

| Event | Description |
|---|---|
| W1 | WLAN becomes better than a threshold |
| W2 | All WLAN inside WLAN mobility set become worse than |
| | a threshold 1 and a WLAN outside WLAN mobility set |
| | become better than a threshold 2 |
| W3 | All WLAN inside WLAN mobility set become worse than a |
| | threshold |

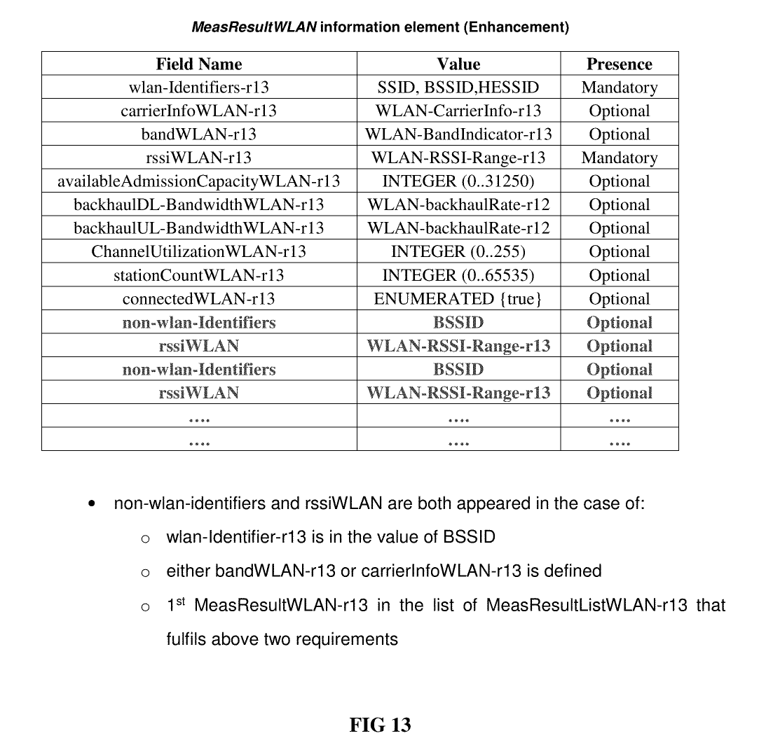

The post-association WLAN measurement report message includes additional fields that are appeared in pair, known as non-wlan-identifiers and rssiWLAN, in the MeasResultWLAN IE as shown in FIG. 13. These pairs of additional fields are added once the UE is able to scan the non-targeted WLAN identifiers within its proximity. For example, if two non-targeted WLAN identifiers are detected, then there will be two pairs of non-wlan-identifiers and rssiWLAN. However, this information will only be added in the 1^{st} MeasResultWLAN IE that fulfils the below two requirements:

the WLAN identifiers is in the value of BSSID;

either WLAN band or carrier info is defined.

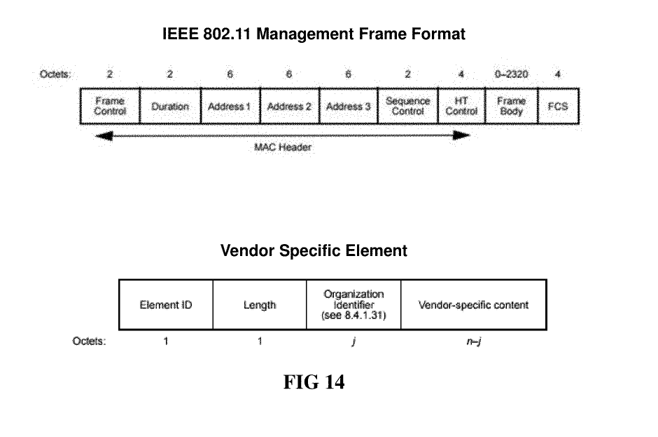

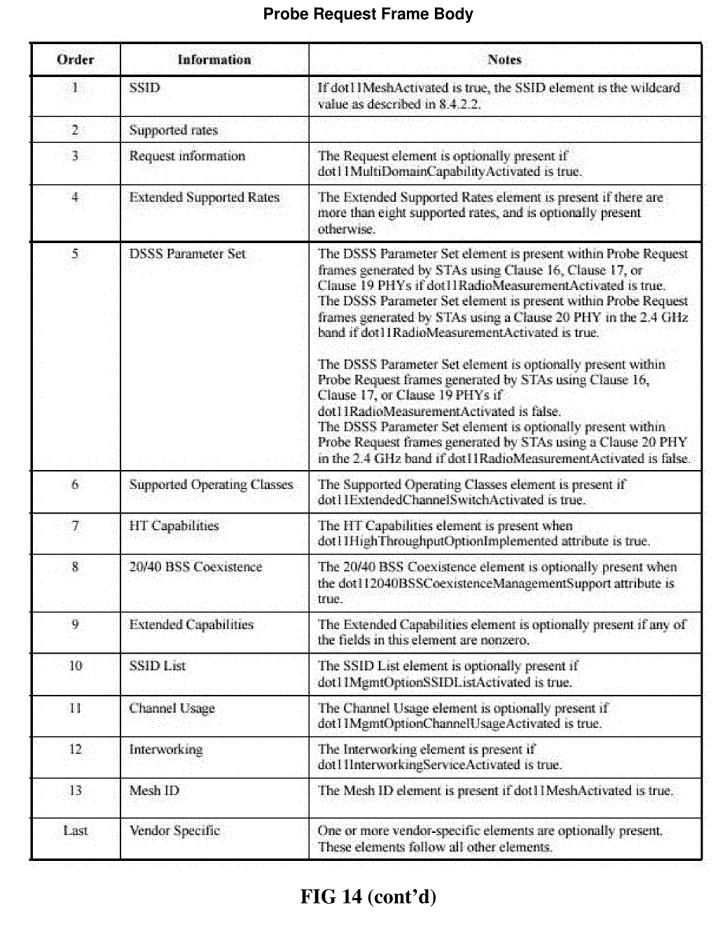

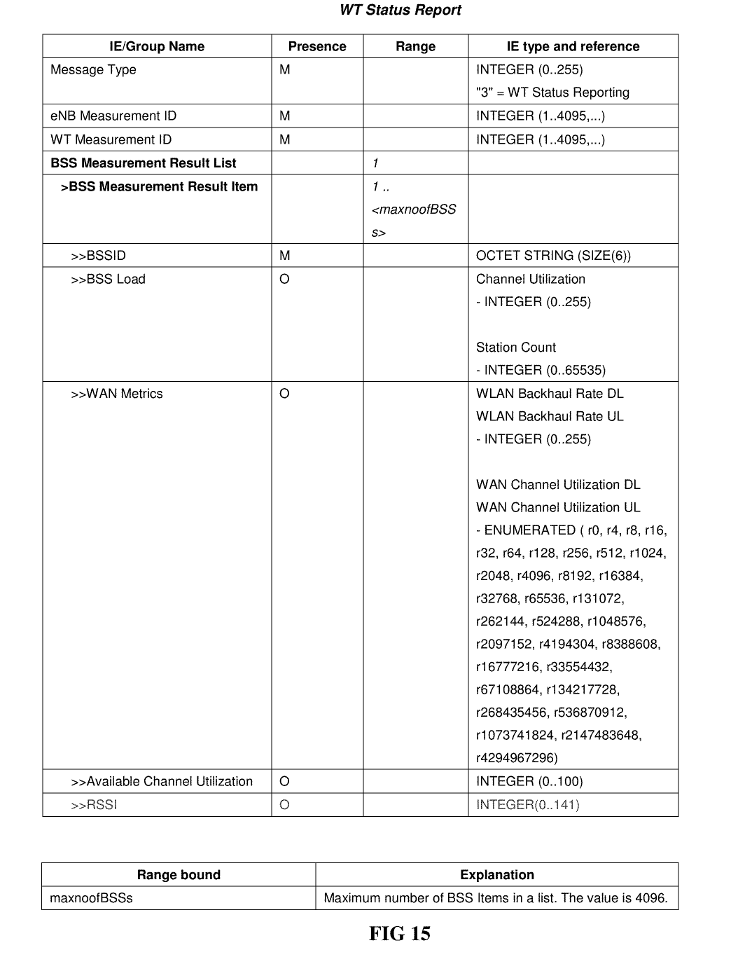

Referring now to FIG. 6, the subsequent post-association WLAN measurement report messages are first sent from the UE to its associated WLAN AP/AC (611), (613). The MeasResultWLAN IE is directly encapsulated to the vendor specific element of IEEE 802.11 probe request management frame as shown in FIG. 14. Then the associated WLAN AP/AC reroutes the post-association WLAN measurement messages to the eNB via Xw interface using WT Status Report message (612), (614) applying additional RSSI IE related to the specified BSSID as shown in FIG. 15.

As defined in 3GPP TS 36.463.v13.0.0, the WT Status Report message as shown in FIG. 15 can contain the Wide Area Network (WAN) metrics. BSS load and available channel utilization. WAN metrics comprise downlink and uplink bandwidth and channel utilization for WLAN backhaul. Meanwhile, the BSS load comprises channel utilization and station count. For LWA, the eNB can request the reporting of load measurements from a WLAN AP/AC via Xw interface. But for LWIP, the eNB depends on the Measurement Report message generated by the UE via Uu interface. Uu interface is the radio interface between the UE and the eNB. However, RSSI for the targeted WLAN identifier can only be retrieved from the Measurement Report message and thus still need to consume the LTE radio resource. As mentioned above, WLAN RSSI measurement can be performed using either active scanning or passive scanning.

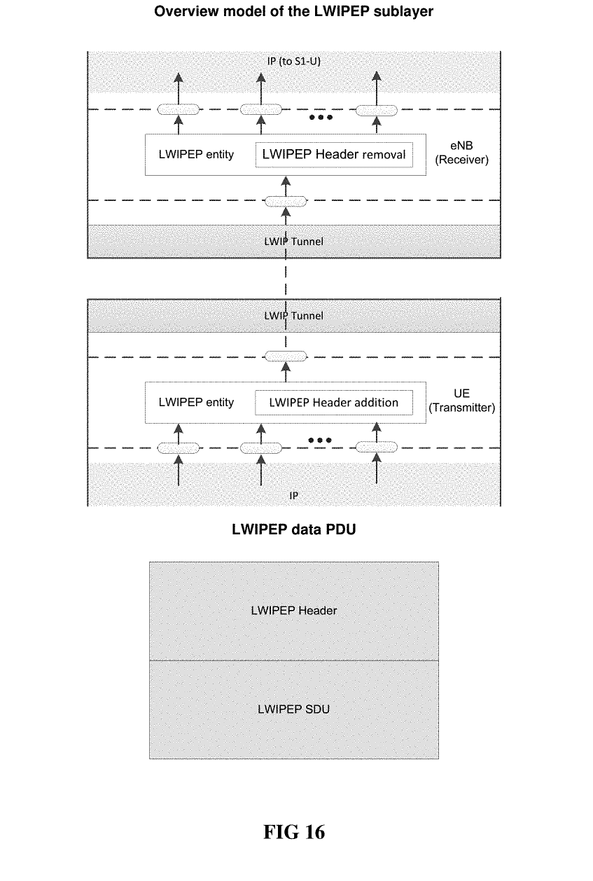

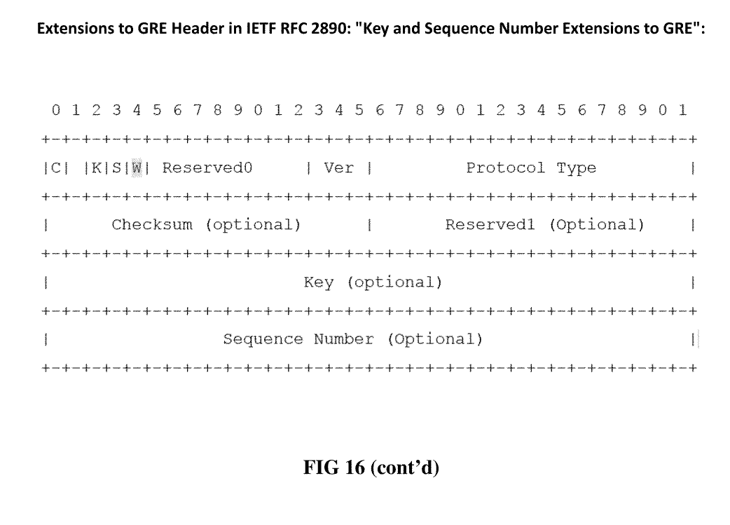

Referring now to FIG. 7, for LWIP, the subsequent post-association WLAN measurement report messages are directly sent to the eNB via IPSec Tunnel via WLAN radio resource (709), (710). The post-association WLAN measurement report message comprising the MeasResultWLAN IE is sent encapsulating as the LWIPEP SDU as shown in FIG. 16. GRE header modification can be used for WLAN measurement reporting detection. The bit-4 of the 1 octet of GRE header or LWIPEP header as according to IETF RFC 2890 is used to indicate the presence of WLAN measurement reporting for LWIP enabled UE.

Therefore, the eNB is managed to receive the UE WLAN measurement reporting for targeted and non-targeted WLAN identifiers via WLAN radio resource instead of relying on the LTE radio resource.

Referring now to FIG. 6, for LWA, based on the post-association Measurement Report, the eNB may decide that another WLAN AP/AC is more optimal for the UE; if it is the case, the steps (608), (609), (610) will be repeated as steps (615), (616), (617).

Referring now to FIG. 7, for LWIP, based on the post-association Measurement Report, the eNB may decide that another WLAN AP/AC is more optimal for the UE; if it is the case, the steps (706), (707), (708), (709) will be repeated as steps (711), (712), (713), (714).

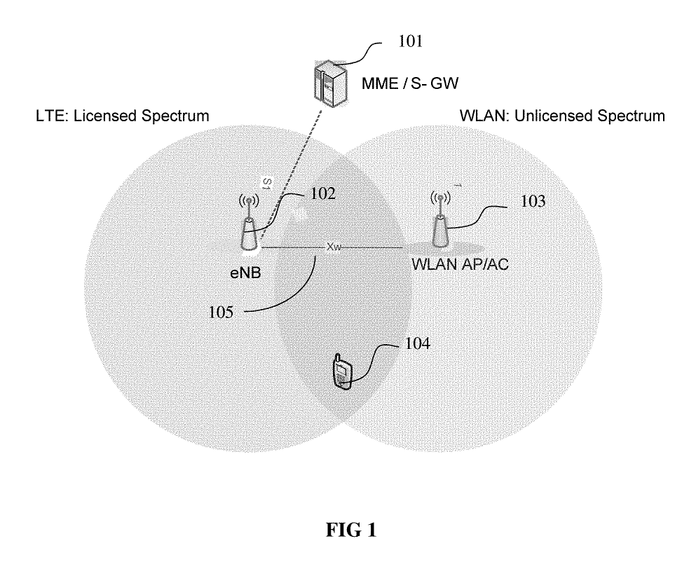

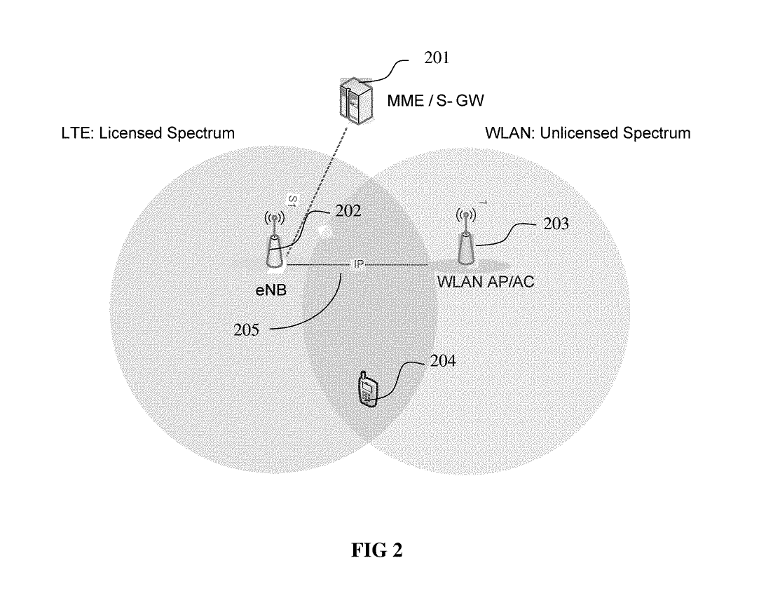

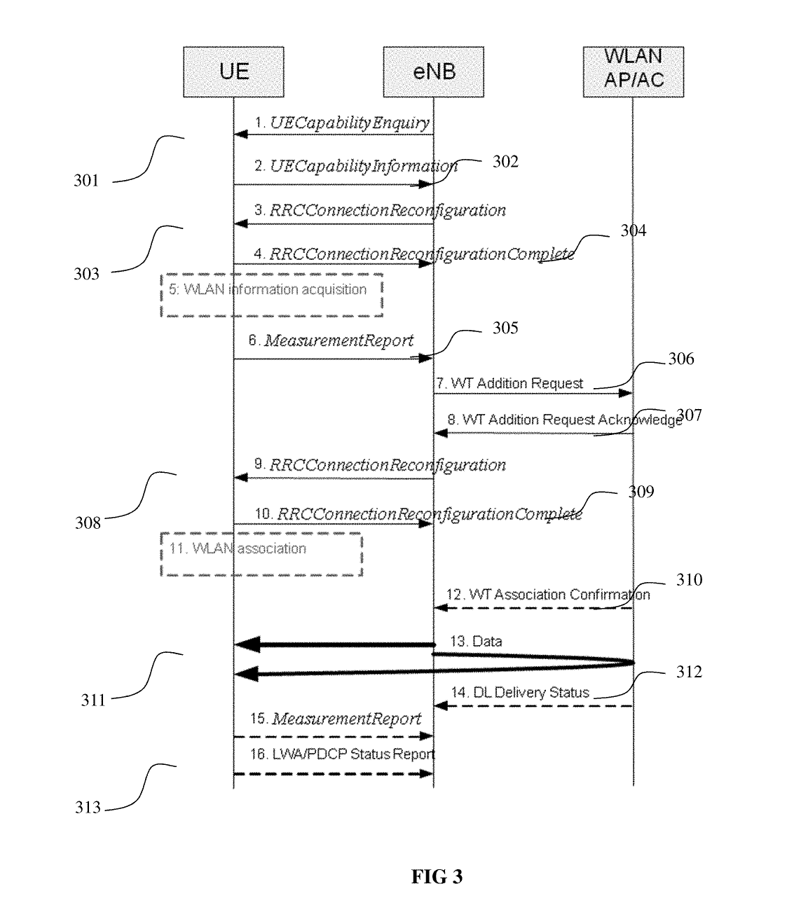

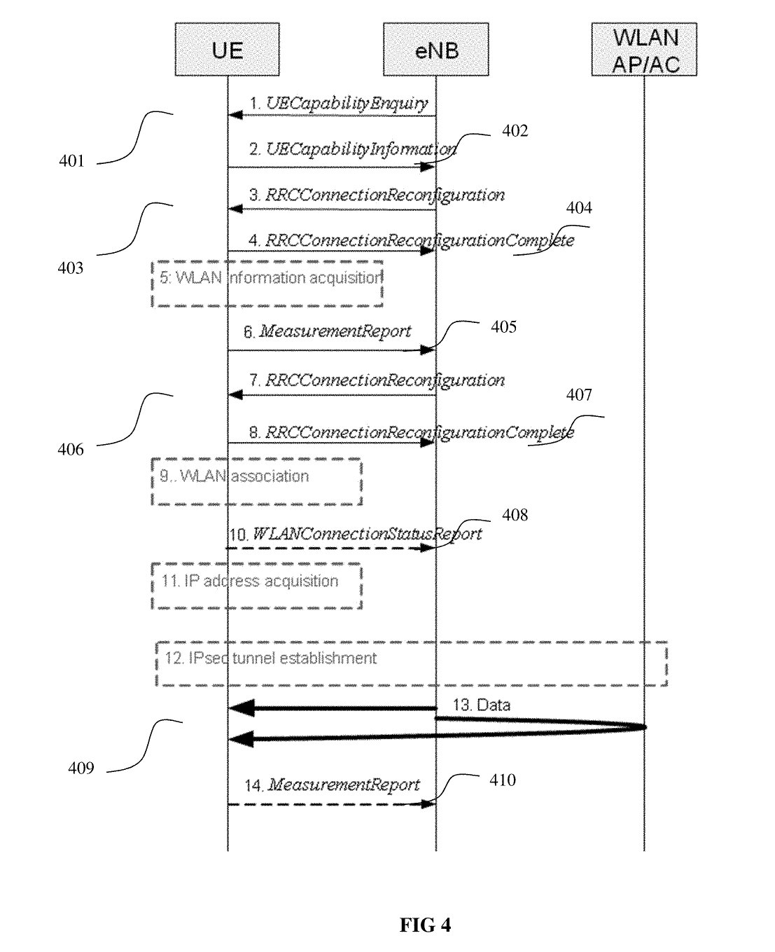

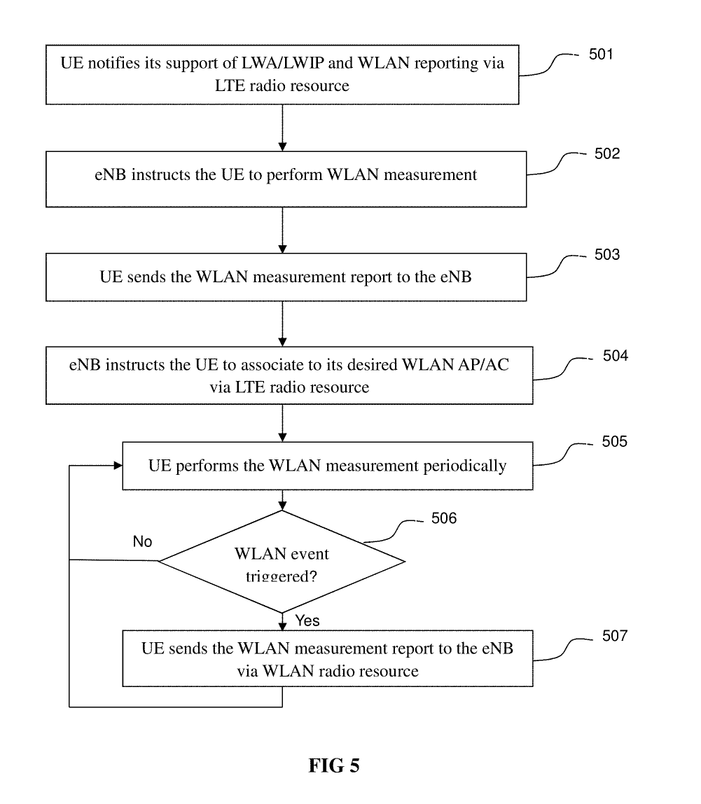

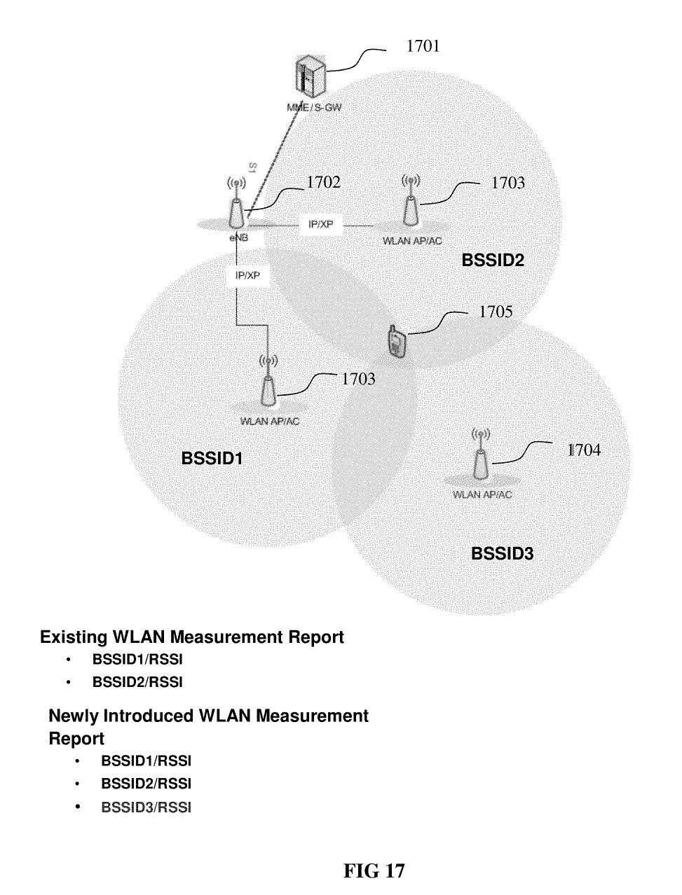

The present invention also provides a wireless communication system with improved UE WLAN measurement reporting. Referring now to FIG. 17, there is provided a functional block diagram of an exemplary wireless communication system in accordance with embodiments of the present invention. The wireless communication system is similar to the LWA and LWIP architectures shown in FIGS. 1 and 2 for including a Mobility Management Entity (MME) and Serving Gateway (S-GW) (1701), an evolved Node B (eNB) (1702) being logically connected to the MME/S-GW, a User Equipment (UE) (1705), but as for the WLAN Access Point (AP) or Access Controller (AC) (WLAN AP/AC), the WLAN AP/AC includes Targeted WLAN identifiers (e.g. BSSID1 and BSSID2) (1703) and non-Targeted WLAN identifiers (e.g. BSSID3) (1704). It is to be noted that the non-Targeted WLAN identifier BSSID3 can be determined to be a Targeted WLAN identifier by the present invention.

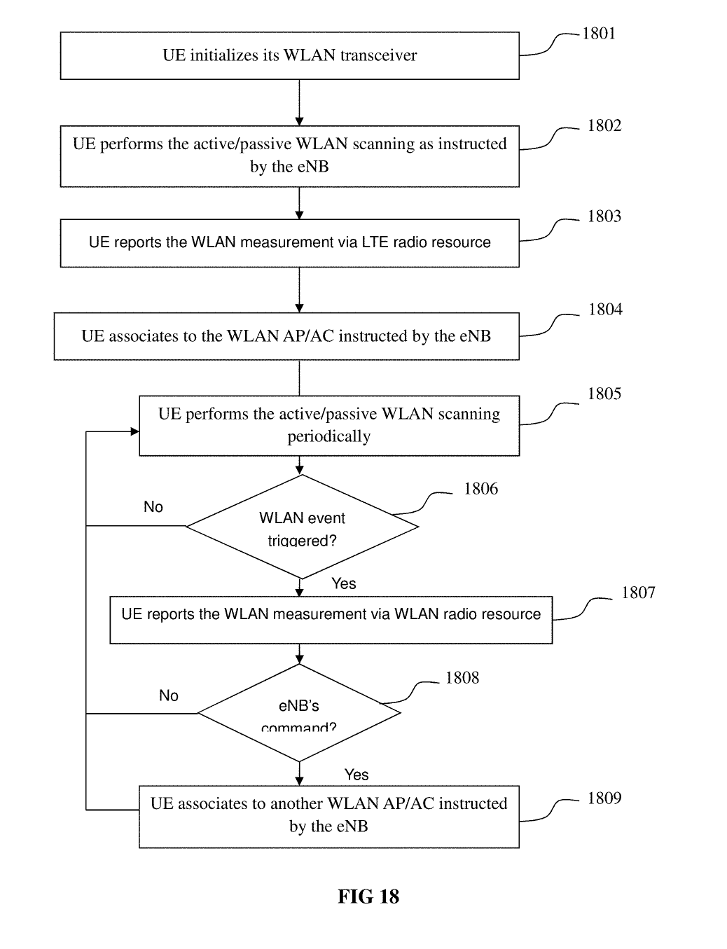

The UE and eNB in the wireless communication system communicate with each other. Referring now to FIG. 18, there is provided a flow chart of UE reporting pre-association WLAN measurement via LTE radio resource and post-association WLAN measurement via WLAN radio resource and its subsequent action based on eNB's command in accordance with embodiments of the present invention. As shown in FIG. 18, the UE performs the following operations:

In the step (1801), the UE initializes its WLAN transceiver;

In the step (1802), the UE performs active or passive scanning as instructed by the eNB for WLAN measurement and generates an initial or pre-association measurement report;

In the step (1803), the UE sends the initial or pre-association WLAN measurement report to the eNB via LTE radio resource;

In the step (1804), the UE associates to the WLAN AP/AC selected by eNB based on the command from the eNB;

In the step (1805), the UE performs the scanning periodically to generate post-association WLAN measurement reports;

In the step (1806), the UE determines if any of the three WLAN events as defined in Table 2 is fulfilled; if No, the UE keeps performing periodic scanning of the step (1805);

In the step (1807), if the determination in the step (1806) is Yes, the UE sends the post-association WLAN measurement reports to the eNB via WLAN radio resource;

In the step (1808), the UE determines if there is a command from the eNB to instruct the UE to associate with another newly selected WLAN AP/AC; if No, go back the step (1805), and the UE keeps continue with periodic scanning and reporting the measurement via WLAN radio resource

In the step (1809), if the determination in the step (1808) is Yes, the UE should associate with the newly selected WLAN AP/AC, and go back the step (1805); and the UE keeps periodic scanning and reporting the measurement via WLAN radio resource.

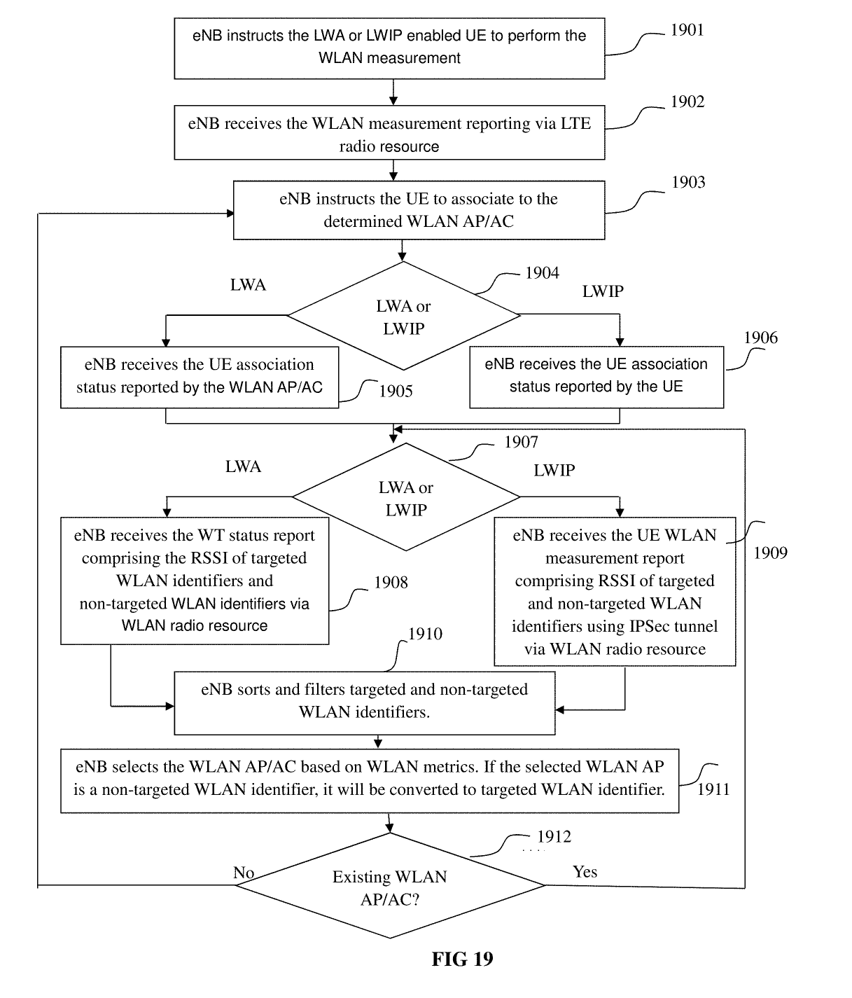

Referring now to FIG. 19, there is provided a flow chart of eNB handling the WLAN measurement received from UE via WLAN radio resource and LTE radio resource and its subsequent action to the UE in accordance with embodiments of the present invention. As shown in FIG. 19, the eNB performs the following operations:

In the step (1901), the eNB sends the command to instruct the UE to perform WLAN scanning after being notified by the UE on its support of LWA and LWIP;

In the step (1902), the eNB receives the initial or pre-association WLAN measurement results via LTE radio resource;

In the step (1903), the eNB selects a WLAN AP/AC for the UE to be associated to, and sends a command to the UE to associate to the selected WLAN AP/AC;

In the step (1904), the eNB decides whether the UE is LWA-enabled or LWIP-enabled;

In the step (1905), if the UE is LWA-enabled, the eNB is awaiting the UE WLAN association status reporting from the WLAN AP/AC;

In the step (1906), if the UE is LWIP-enable, the eNB is awaiting the UE WLAN association status reporting from the UE;

In the step (1907), the eNB decides whether the UE is LWA-enabled or LWIP-enabled;

In the step (1908), if the UE is LWA-enabled, the eNB receives the WT status report comprising the RSSI of targeted WLAN identifiers and non-targeted WLAN identifiers via WLAN radio resource;

In the step (1909), if the UE is LWIP-enabled, the eNB receives the UE WLAN measurement report comprising RSSI of targeted and non-targeted WLAN identifiers using IPSec tunnel via WLAN radio resource.

In the step (1910), the eNB performs the filtering and sorting algorithm of targeted and non-targeted WLAN identifiers as described hereinbelow;

In the step (1911), the eNB can then select the optimized WLAN AP/AC for traffic aggregation considering the non-targeted WLAN identifier and other related WLAN metrics; if the selected WLAN AP/AC for traffic aggregation is a non-targeted WLAN identifier, it will be converted to targeted WLAN identifier;

In the step (1912), if the current WLAN AP/AC is still chosen, go back to the step (1907), then the eNB keeps monitoring the WLAN measurement report via WLAN radio resource; if the current WLAN AP/AC is not chosen, go back to the step (1903).

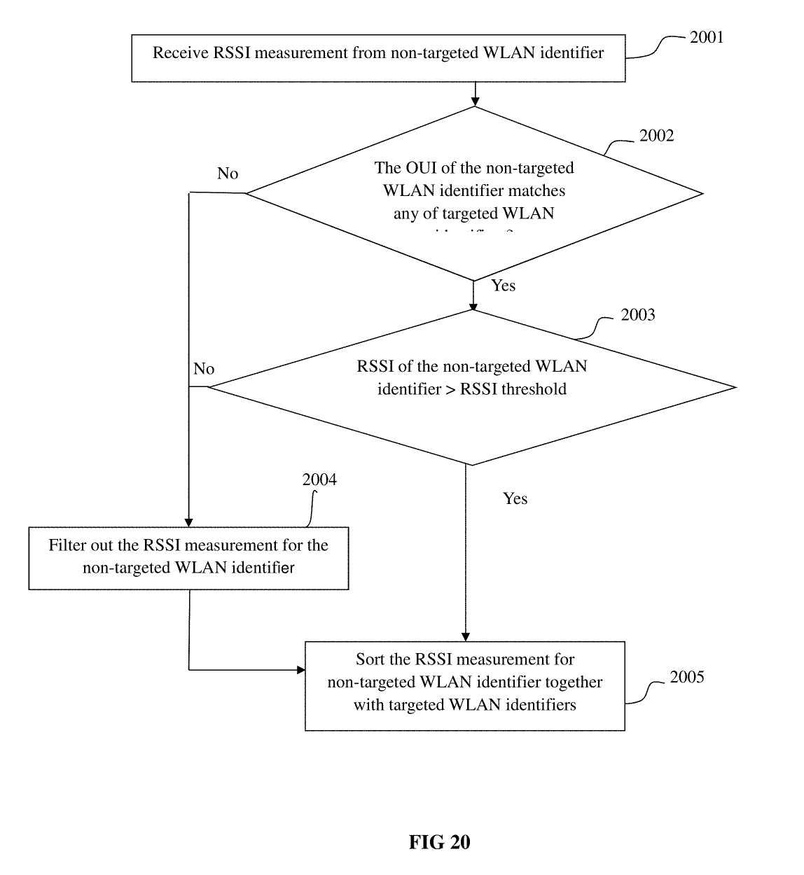

Referring now to FIG. 20, there is provided a filtering and sorting algorithm for targeted and non-targeted WLAN identifiers in accordance with embodiments of the present invention.

In the step (2001), the eNB receives RSSI measurement from non-targeted WLAN identifier;

In the step (2002), the filtering is applying only on non-targeted WLAN identifiers; the eNB determines if the OUI of the non-targeted WLAN identifier matches the OUI of BSSID for at least one of the targeted WLAN identifiers;

In the step (2003), if Yes in the step (2002), the eNB determines if the RSSI of the non-targeted WLAN identifier is larger than the defined RSSI threshold; the RSSI threshold can be based on the average or median of RSSI for targeted WLAN identifiers;

In the step (2004), if No in the steps (2002) and (2003), the eNB filters out the RSSI measurement for the non-targeted WLAN identifier;

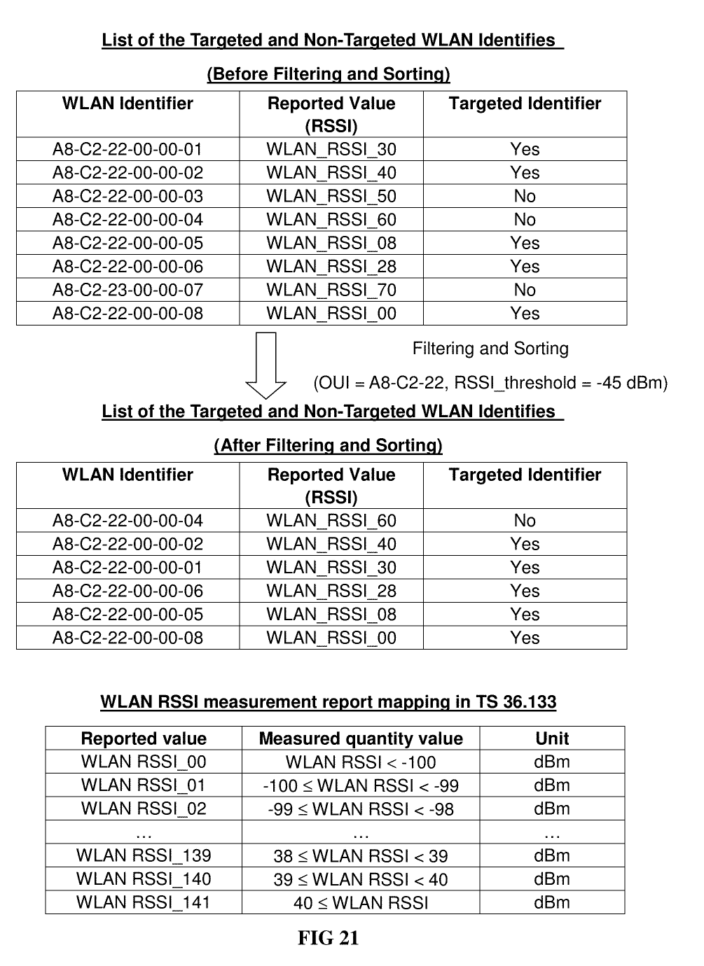

In the step (2005), if Yes in the step (2003), and after filtering in the step (2004), the eNB sorts the RSSI measurement for non-targeted WLAN identifier together with targeted WLAN identifiers; FIG. 21 provides an exemplary sorting as performed in accordance with embodiments of the present invention.

The present invention has many unique features. For example, the UE uses header modification and new fields introduced into Measurement Report message (RRC signaling message) and WT Status Report (Xw application message), so that the measurement report can be sent via WLAN radio source, and the new fields are used for XWAP and RRC signaling message for reporting RSSI for non-targeted WLAN identifiers.

The present invention has many advantages; for example:

1. Increase LTE capacity: utilizing WLAN radio resource;

2. Reduce the complexity of protocol implementation in the UE: utilizing active scanning procedure in the UE for WLAN measurement reporting;

3. Better selection of WLAN AP within the proximity of the UE for LWA: enhancing the current state-of-art reporting mechanism to include the non-targeted WLAN identifiers to avoid the best WLAN AP being dropped from consideration.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the scope of the present invention. Accordingly, the scope of the present invention is defined by the appended claims and is supported by the foregoing description.

What is claimed is:

1. A method for improving the UE WLAN measurement reporting for both LWA and LWIP, wherein both LWA and LWIP comprises a eNB, a WLAN AP/AC and a UE, said method comprising the steps of:
notifying the eNB by the UE for its support of LWA or LWIP and WLAN reporting via LTE radio resource;
instructing the UE by the eNB to perform initial WLAN measurement;
sending the initial WLAN measurement report to the eNB via LTE radio resource by the UE;
instructing the UE by the eNB to be associated to a WLAN AP/AC selected by the eNB;
performing post-association WLAN measurement periodically to generate post-association measurement report;
determining if a WLAN event is triggered; if No, performing the WLAN measurement periodically; if Yes, the UE sends the post-association WLAN measurement report to the eNB via WLAN radio resource and then performing the WLAN measurement periodically.

2. The method of claim 1, wherein before the step of notifying the eNB by the UE for its support of LWA or LWIP and WLAN reporting via LTE radio resource, further comprising:
sending a request by the eNB to a UE for the UE capability using UE Capability Enquiry message;
thereby the UE notifies the eNB with the support of LWA and WLAN measurement reporting via LTE radio resource using UE Capability Information message.

3. The method of claim 2, wherein the UE Capability Information message comprises a UE-EUTRA-Capability information element, wherein the support of WLAN measurement reporting via LTE radio resource is indicated by using additional fields in the UE EUTRA Capability information element, known as lwa-wlan-reporting and lwip-wlan-reporting in the LWA-parameters and LWIP parameters respectively.

4. The method of claim 1, wherein the step of instructing the UE by the eNB to associate to a WLAN AP/AC selected by the eNB comprises:
sending by the eNB a RRC Connection Reconfiguration message to the UE;
replying by the UE with a RRC Connection Reconfiguration Complete message to the eNB;
for LWA, the associated WLAN AP/AC notifies the eNB about the UE association using WT Association Confirmation message via Xw interface;
for LWIP, the UE notifies its WLAN association status to the eNB using the WLAN Connection Status Report message.

5. The method of claim 1, wherein in the step of determining if a WLAN event is triggered, the event includes: WLAN becomes better than a threshold; all WLAN inside WLAN mobility set become worse than a threshold 1 and a WLAN outside WLAN mobility set become better than a threshold 2; all WLAN inside WLAN mobility set become worse than a threshold.

6. The method of claim 1, wherein the post-association WLAN measurement report includes additional fields that are appeared in pair, known as non-wlan-identifiers and rssiWLAN, in the MeasResultWLAN IE.

7. The method of claim 1, wherein when the UE sends the post-association WLAN measurement report to the eNB via WLAN radio resource, depending upon LWA or LWIP:
for LWA, the post-association WLAN measurement report is first sent from the UE to its associated WLAN AP/AC; then the MeasResultWLAN IE is directly encapsulated to the vendor specific element of IEEE 802.11 probe request management frame; and then the associated WLAN AP/AC reroutes the post-association WLAN measurement report to the eNB via Xw interface using WT Status Report message applying additional RSSI IE related to specified BSSID;
for LWIP, the post-association WLAN measurement report is directly sent to the eNB via IPSec Tunnel via WLAN radio resource; wherein the post-association WLAN measurement report comprising the MeasResultWLAN IE is sent encapsulating as the LWIPEP SDU.

8. The method of claim 1, wherein the post-association WLAN measurement report includes targeted and non-targeted WLAN identifiers.

9. A wireless communication system with improved UE WLAN measurement reporting, comprising a Mobility Management Entity (MME) and Serving Gateway (S-GW), an evolved Node B (eNB) being logically connected to the MME/S-GW, a User Equipment (UE), a WLAN AP/AC with Targeted WLAN identifiers, and a WLAN AP/AC with non-Targeted WLAN identifiers;
wherein the UE performs WLAN measurement periodically after being associated with one WLAN AP/AC, and sends post-association WLAN measurement report to the eNB via WLAN radio resource.

10. The wireless communication system of claim 9, wherein the UE is embedded with an electronically executable program for performing the following operations:
initializing its WLAN transceiver;
performing active or passive scanning as instructed by the eNB for WLAN measurement and generates an initial or pre-association measurement report;
sending the initial or pre-association WLAN measurement report to the eNB via LTE radio resource;
associating to the WLAN AP/AC selected by eNB based on the command from the eNB;
performing the scanning periodically to generate post-association WLAN measurement reports;
determining if the WLAN event as defined in Table 2 is fulfilled; if No, keeping performing periodic scanning; if Yes, sending the post-association WLAN measurement reports to the eNB via WLAN radio resource.

11. The wireless communication system of claim 10, wherein the electronically executable program further comprises the following operations:
determining if there is a command from the eNB to instruct the UE to associate with another newly selected WLAN AP/AC; if No, keeping performing periodic scanning and reporting the measurement via WLAN radio resource; if Yes, associating with the newly selected WLAN AP/AC, and keeping periodic scanning and reporting the measurement via WLAN radio resource.

12. The wireless communication system of claim 9, wherein the eNB is embedded with an electronically executable program for performing the following operations:
sending a command to instruct the UE to perform WLAN scanning after being notified by the UE on its support of LWA and LWIP;
receiving initial or pre-association WLAN measurement results via LTE radio resource;
selecting a WLAN AP/AC for the UE to be associated to, and sends a command to the UE to associate to the selected WLAN AP/AC;
deciding whether the UE is LWA-enabled or LWIP-enabled; if the UE is LWA-enabled, awaiting the UE WLAN association status reporting from the WLAN AP/AC; if the UE is LWIP-enable, awaiting the UE WLAN association status reporting from the UE;
deciding whether the UE is LWA-enabled or LWIP-enabled; if the UE is LWA-enabled, receiving the WT status report comprising the RSSI of targeted WLAN identifiers and non-targeted WLAN identifiers via WLAN radio resource; if the UE is LWIP-enabled, receiving the UE WLAN measurement report comprising RSSI of targeted and non-targeted WLAN identifiers using IPSec tunnel via WLAN radio resource;
performs filtering and sorting algorithm of targeted and non-targeted WLAN identifiers;
selecting WLAN AP/AC for traffic aggregation considering non-targeted WLAN identifier and other related WLAN metrics; if the selected WLAN AP/AC for traffic aggregation is a non-targeted WLAN identifier, it will be converted to targeted WLAN identifier.

13. The wireless communication system of claim 12, wherein the filtering and sorting algorithm of targeted and non-targeted WLAN identifiers comprises the following operations:
receiving RSSI measurement from non-targeted WLAN identifier;
determining if the OUI of the non-targeted WLAN identifier matches the OUI of BSSID for at least one of the targeted WLAN identifiers; if Yes, determining if the RSSI of the non-targeted WLAN identifier is larger than the defined RSSI threshold; if No, filtering out the RSSI measurement for the non-targeted WLAN identifier; if Yes, sorting the RSSI measurement for non-targeted WLAN identifier together with targeted WLAN identifiers.

14. The wireless communication system of claim 13, wherein the RSSI threshold can be based on the average or median of RSSI for targeted WLAN identifiers.
